(19) United States
(12) Patent Application Publication
(10) Pub. No.: US 2006/0276732 A1
(43) Pub. Date: Dec. 7, 2006

(54) Roller massager

(76) Inventor: Chen Ching Chen, Chang Hua Hsien (TW)

Correspondence Address: TROXELL LAW OFFICE PLLC, SUITE 1404, 5205 LEESBURG PIKE, FALLS CHURCH, VA, 22041, US

(21) Appl. No.: 11/140,939

(22) Filed: Jun. 1, 2005

(51) Int. Cl. A61H 15/00

(52) U.S. Cl. 601/113; 601/120; 601/123; 601/125; 601/129

(57) ABSTRACT

A roller massager having a handle and two rollers mounted on two sides of the handle. When pushing/pulling the massager, the rollers roll on human body to provide a massaging effect. When in use, the axis of the rollers and the length of the handle contain an angle which is not right angle. In use of the roller massager, the rollers can inward squeeze the muscle of a user to achieve a kneading and massaging effect.

### BACKGROUND OF THE INVENTION

The present invention is related to a massager, and more particularly to a roller massager which provides both pressing effect and kneading effect for the skin and muscle of a user.

FIG. 1 shows a conventional massager 10 having a handle 12 and two rollers 14 pivotally mounted on two sides of one end of the handle 12. In use, the rollers 14 are pressed against the surface of a human body to roll back and forth thereon so as to provide a massaging and relaxing effect for the skin and muscle.

The two rollers 14 of the conventional massager 10 are coaxially arranged. The axis X of the rollers 14 is perpendicular to the axis Y of the handle. In actual use, the rollers 14 can only exert a pressing force onto the skin and muscle of a user. In comparison with manual massage, the massaging effect of the conventional massager is relatively poor.

### SUMMARY OF THE INVENTION

It is therefore a primary object of the present invention to provide a roller massager which provides a kneading and massaging effect for the muscle of human body.

It is a further object of the present invention to provide the above roller massager in which the intensity of the kneading effect is adjustable as necessary.

It is still a further object of the present invention to provide the above roller massager which can be moved back and forth to provide kneading effect.

The present invention can be best understood through the following description and accompanying drawings wherein:

### BRIEF DESCRIPTION OF THE DRAWINGS

FIG. 1 is a view of a conventional massager;

FIG. 2 is a perspective-view of a preferred embodiment of the present invention, showing the use thereof;

FIG. 3 is a perspective exploded view of the preferred embodiment of the present invention according to FIG. 2;

FIG. 4 is a cross-sectional view according to FIG. 2;

FIG. 5 is a top view according to FIG. 2;

FIG. 6 is a sectional view of another embodiment of the present invention;

FIG. 7 is a sectional view of another embodiment of the present invention;

FIG. 8 is a perspective exploded view of still another embodiment of the present invention;

FIG. 9 is a longitudinal sectional assembled view of the embodiment of FIG. 8;

FIG. 10 is a perspective exploded view of still another embodiment of the present invention;

FIG. 11 is a longitudinal sectional assembled view of the embodiment of FIG. 10;

FIG. 12 is a perspective view of still another embodiment of the present invention;

FIG. 13 is a perspective exploded view of the embodiment of FIG. 12;

FIG. 14 is a cross-sectional view of the embodiment of FIG. 12;

FIG. 15 shows the operation of the embodiment of FIG. 12;

FIG. 16 is a perspective assembled view of still another embodiment of the present invention; and

FIG. 17 is a top view of still another embodiment of the present invention.

### DETAILED DESCRIPTION OF THE PREFERRED EMBODIMENTS

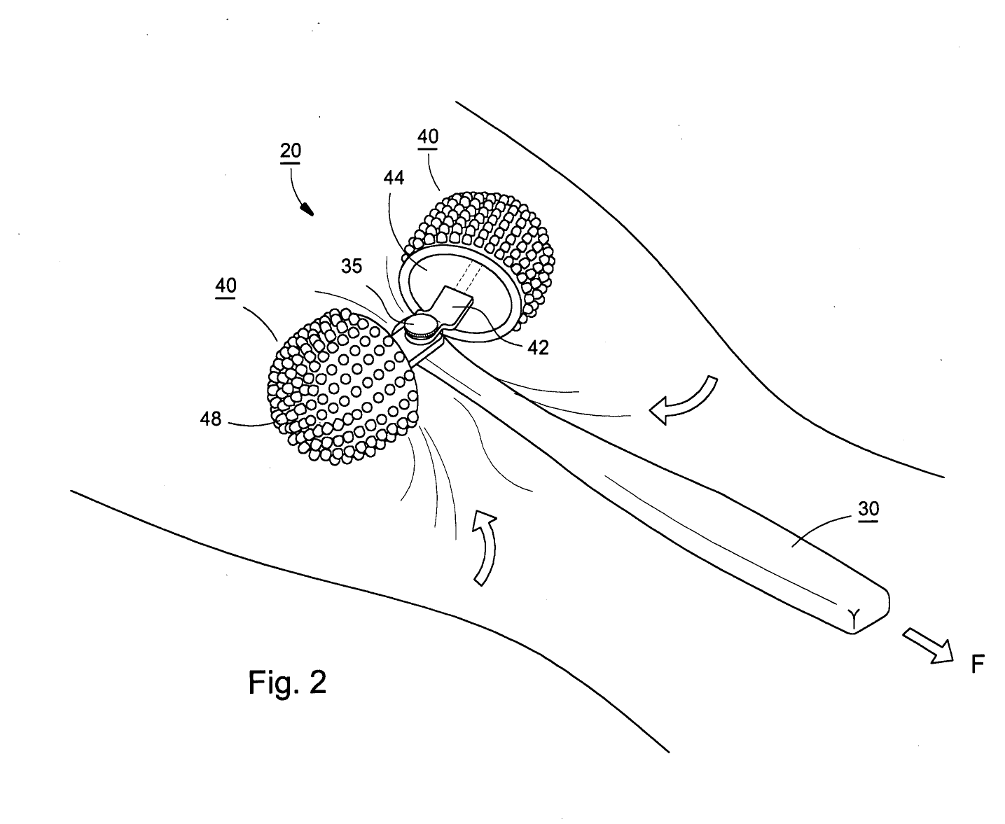

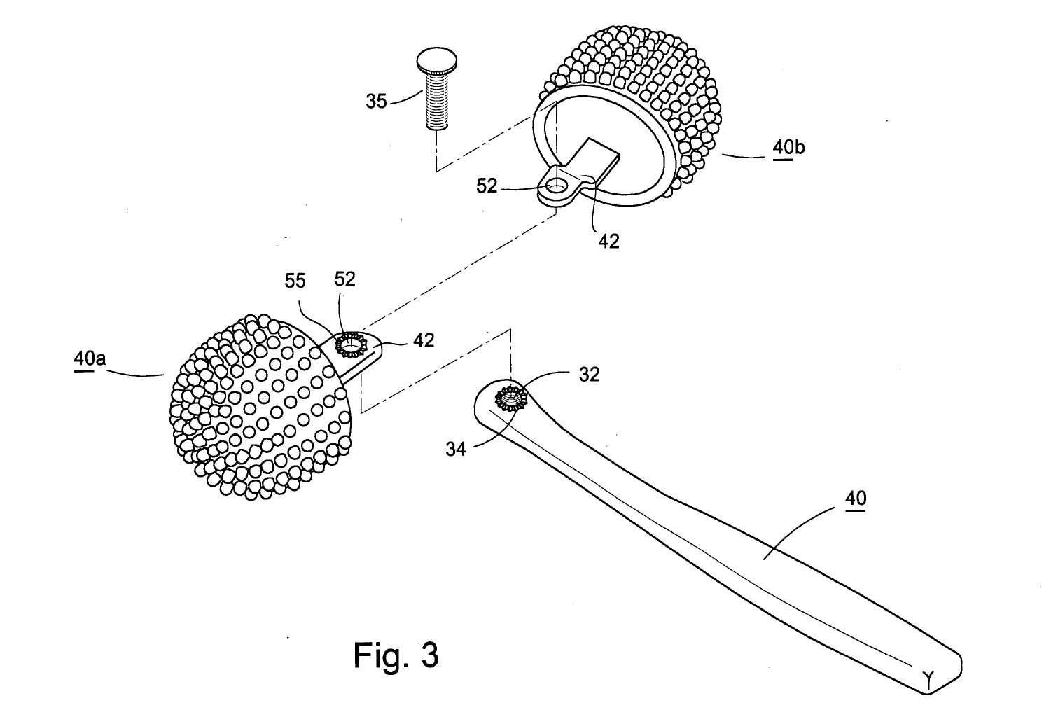

Please refer to FIGS. 2 and 3. According to a preferred embodiment, the massager 20 of the present invention includes a handle 30 and two rollers 40 each having a shaft 42. The shafts 42 of the rollers 40 are respectively mounted on two sides of one end of the handle 30.

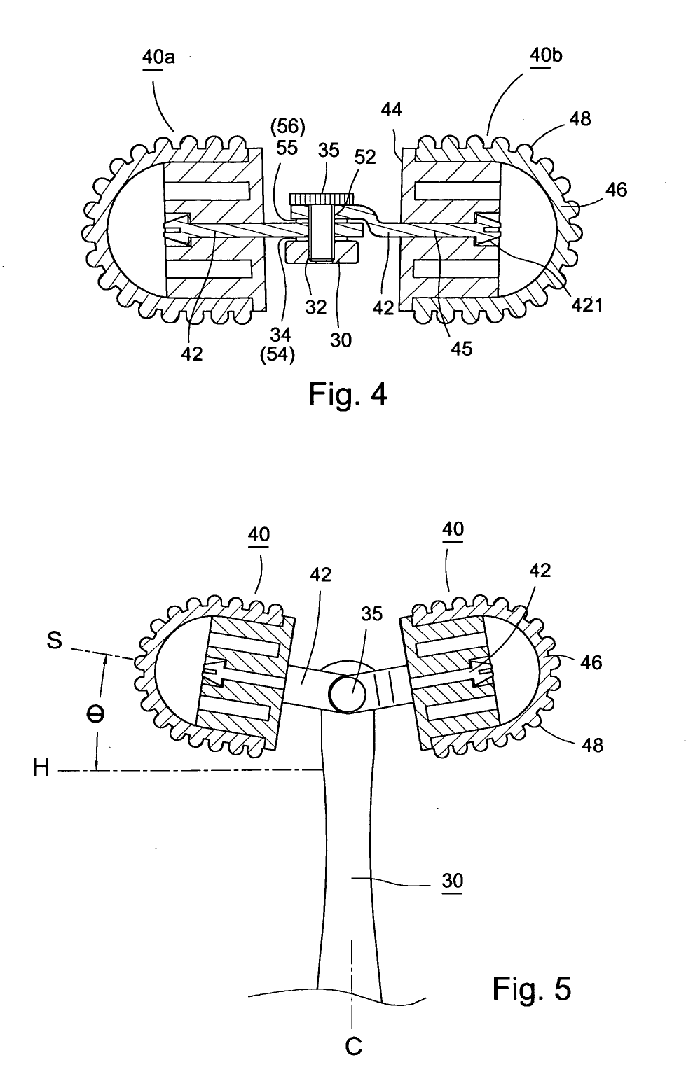

Referring to FIG. 4, each roller. 40 has a roller main body 44 and a soft roller cap 46 fitted around the main body 44. A predetermined number of massaging bosses 48 are densely distributed over the surface of the roller cap 46. The shaft 42 is fitted in a shaft hole 45 of the main body 44, whereby the roller 40 can be rotated. The shaft 44 has an arrow-headed portion 421 for hooking the main body 44 so as to prevent the roller from detaching from the shaft.

The shafts 42 of the rollers 40 are pivotally connected with the handle 30 via a screwed member 35 screwed in a threaded hole 32 of front end of the handle 30. The rollers 40 can be pivoted about the screwed member 35 to change the angular positions.

An engaging section 34 is formed on top face of the handle 30 around the threaded hole 32. The engaging section 34 includes multiple annularly arranged teeth.

Referring to FIGS. 3 and 4, two engaging portions 54, 55 are respectively formed on top and bottom faces of inner end of the shaft 42 of the first roller 40a around the pivot hole 52. In addition, an engaging portion 56 is formed on bottom face of the shaft 42 of the second roller 40b around the pivot hole 52. Each of the engaging portions 54, 55, 56 includes multiple annularly arranged teeth.

The screwed member 35 is passed through the pivot holes 52 of the shafts and screwed into the threaded hole 32 of the handle. After the screwed member is tightened, the engaging portion 54 of the bottom face of the first roller 40a is engaged with the engaging section 34 of the handle 30 and located as shown in FIG. 4. Similarly, the engaging portion 56 of the second roller 40b is engaged with the engaging portion 55 of the top face of the first roller and located. Accordingly, the handle and the rollers are engaged with each other to fix the rollers 40.

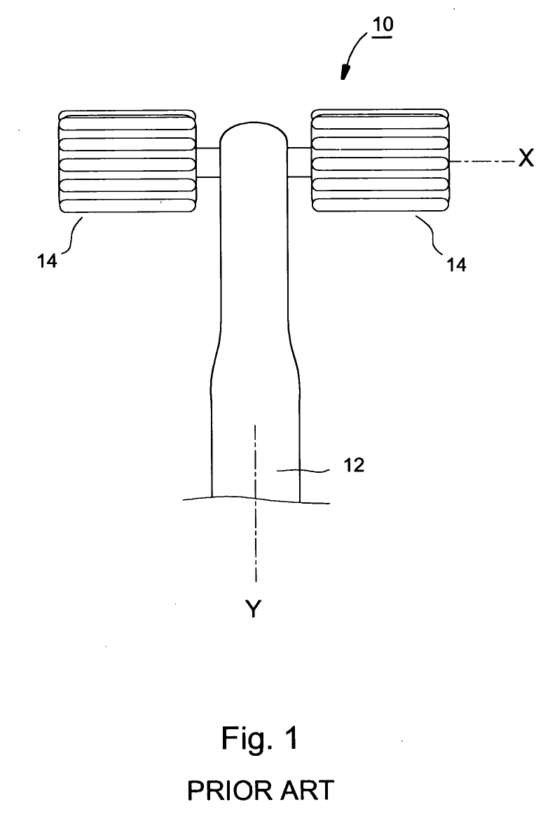

Referring to FIG. 5, the handle 30 has a vertical axis C and a horizontal axis H. A user can locate the rollers 40 by a specific inclination angle, whereby the axis S of the roller and the horizontal axis H of the handle contain an angle θ. When back and forth rolling the rollers 40 of the massager 20 on a human body as shown in FIG. 2, the bosses 48 of the rollers 40 press the skin and muscle of a user to achieve a massaging effect. The present invention is characterized in that when the massager is rearward pulled in direction F, the skin and muscle relatively move from larger gap to smaller gap between the rollers 40. At this time, the muscle is squeezed inward as kneaded with fingers. It is found through actual use that such massaging effect is much higher than the conventional massager of FIG. 1.

Reversely, when the massager is pushed in reverse direction, the muscle is pressed and tensioned outward. Therefore, the massager 20 can provide pressing, inward kneading and outward tensioning effect for the skin and muscle of a user.

When the screwed member 35 is unscrewed, the rollers 40 are released from the located state. Under such circumstance, the angle of the rollers can be adjusted into a different inclination angle. After adjusted, the screwed member is retightened to engage the engaging section 34 and the engaging portions 54, 55, 56 with each other and locate the rollers in a different angular position. The larger the inclination angle of the rollers is, the larger the angle θ is. That is, the muscle is more apparently inward squeezed by the rollers. Reversely, the smaller the inclination angle of the rollers is, the smaller the angle θ is. That is, the muscle is more tenderly inward squeezed by the rollers. Accordingly, a user himself/herself can adjust the intensity of the kneading effect as necessary to achieve an optimal massaging effect.

FIG. 6 is a sectional view of another embodiment of the massager 60 of the present invention. Similarly, the shafts 66 of the rollers 65 are pivotally connected with one end of the handle 61 via a screwed member 62 (a bolt and a nut). The first roller 65a is pivotally connected under the bottom face of the handle 61, while the second roller 65b is pivotally connected on top face of the handle. Two engaging sections 63, 64 are respectively disposed on top and bottom faces of the handle 61. An engaging portion 67 is formed on top face of the shaft of the first roller 65a for engaging with the bottom engaging section 63 of the handle. An engaging portion 68 is formed under bottom face of the shaft of the second roller 65b for engaging with the top engaging section 64 of the handle. Similarly, a user can adjust the inclination angle of the rollers.

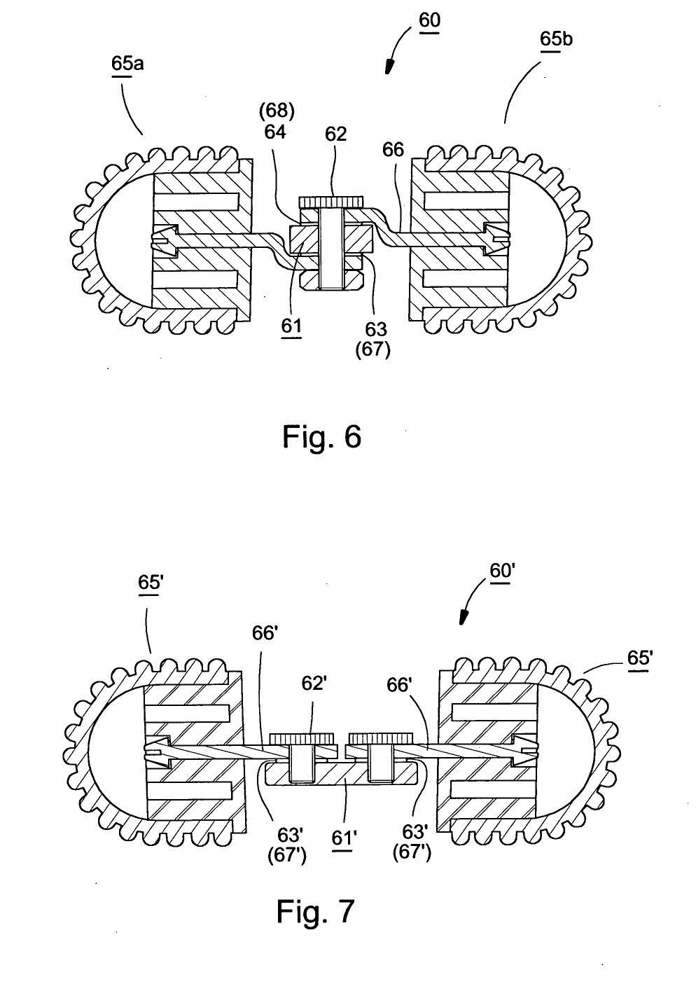

FIG. 7 is a sectional view of another embodiment of the massager 60′ of the present invention. Two engaging sections 63′ are formed on top face of the handle 61′. The shafts 66′ of the rollers 65′ are pivotally connected on the top face of the handle 61′ via two screwed members 62′. A bottom face of each shaft 66′ is formed with an engaging portion 67′ , each the engaging portion 67′ is engaged with each the engaging section 63′ of the handle. Similarly, a user can adjust the inclination angle of the rollers.

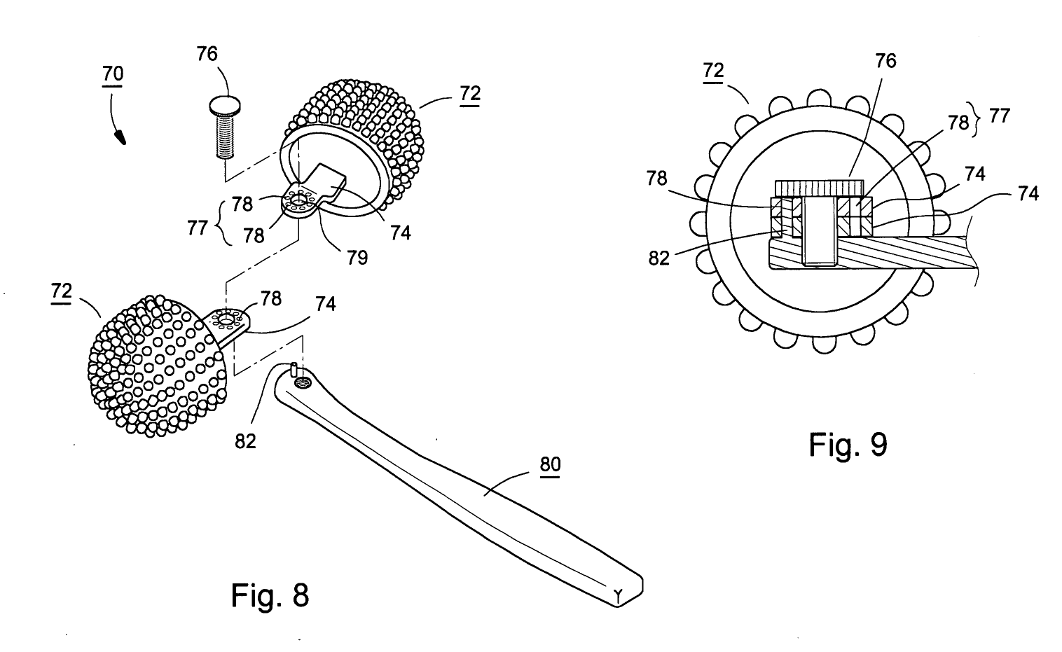

FIGS. 8 and 9 show still another embodiment of the massager 70 of the present invention. Similarly, the shafts 74 of the rollers 72 are pivotally connected with one end of the handle 80 via a screwed member 76. In this embodiment, the engaging section 82 of the handle is a pin fixed on the handle. The pin upward projects from top face of the handle. The engaging portion 77 of each roller includes multiple annularly arranged holes 78. The holes 78 and the pivot hole 79 of the roller are concentrically arranged.

Referring to FIG. 9, after assembled, the pin 82 of the handle is fitted through one hole 78 of the rollers 72 to locate the rollers in a specific angular position. Similarly, the angle of the rollers can be adjusted as necessary.

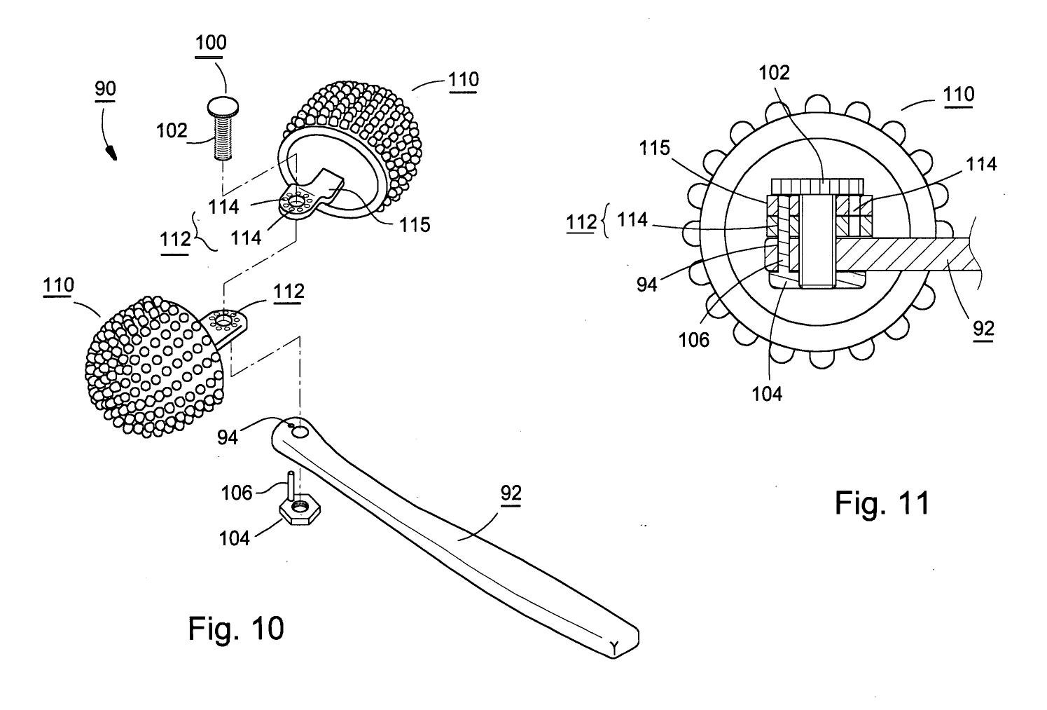

FIGS. 10 and 11 show still another embodiment of the massager 90 of the present invention. Similarly, the rollers 110 are pivotally connected with the handle 92 via a screwed member 100. In this embodiment, the screwed member includes a screw 102 and a nut 104. The engaging section 106 is fixedly disposed on top face of the nut 104 and the handle is formed with a pinhole 94.

Referring to FIG. 11, after assembled, the engaging section 106 of the nut is fitted through one hole 114 of the engaging portions 112 of the rollers 110 and the pinhole 94 of the handle 92 so as to locate the rollers in a specific angular position.

FIG. 11 shows that the shafts 115 of the rollers are mounted on the same face of the handle 92. Alternatively, the shafts 115 of the rollers can be respectively mounted on the top and bottom faces of the handle.

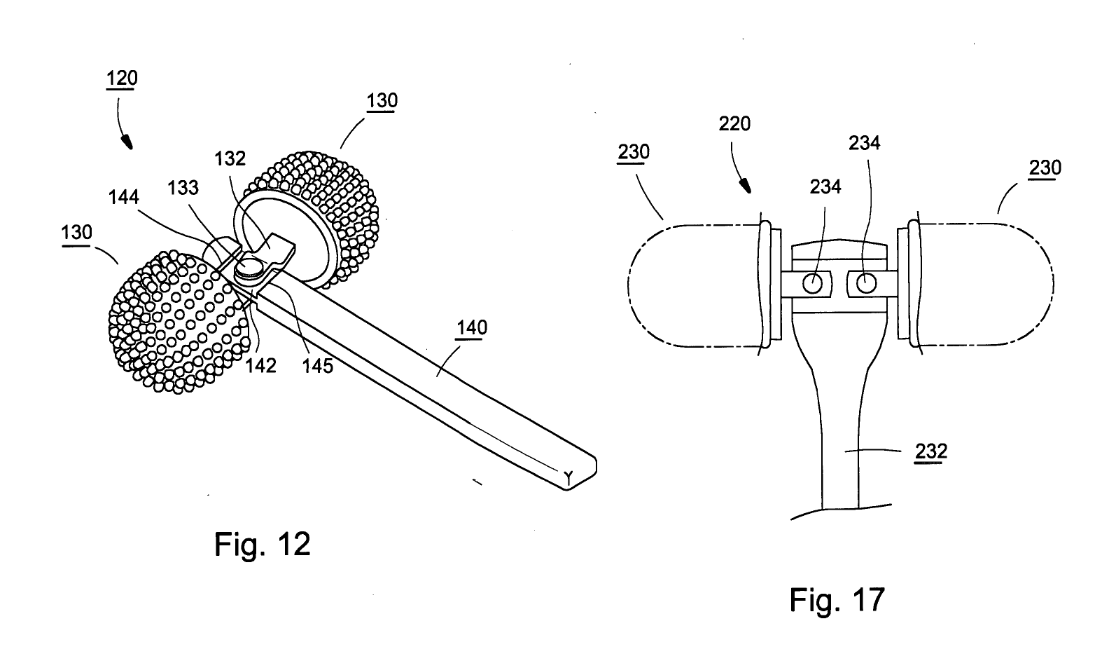

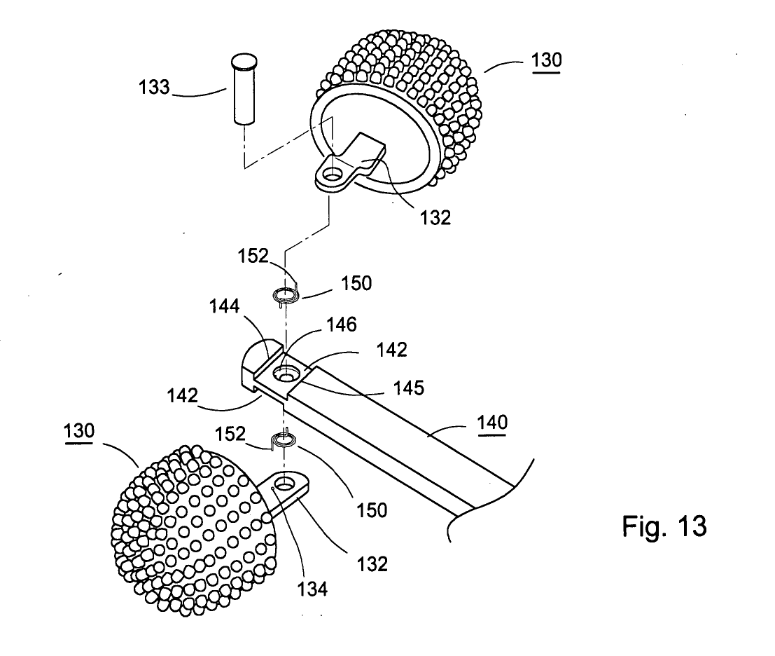

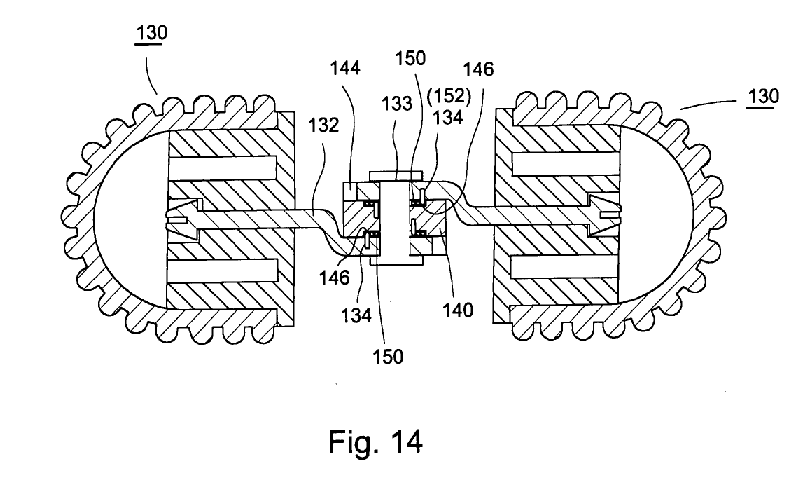

FIG. 12 shows still another embodiment of the massager 120 of the present invention. The shafts 132 of the rollers 130 are pivotally connected with the handle 140 via a central shaft 133, whereby the rollers 130 can be freely pivoted about the central shaft. Referring to FIGS. 13 and 14, in this embodiment, the top and bottom faces of the handle 140 are respectively formed with two depressions 142. The shafts 132 of the rollers 130 are respectively positioned in the depressions 142 of the handle. A front end and a rear end of each depression respectively serve as two restricting portions 144, 145. Two dents 146 are respectively formed on the bottoms of the depressions 142. Two torque springs 150 are respectively placed in the dents 146. One end of each torque spring 150 is fixed on the handle 140, while the other end 152 of the torque spring 150 is inlaid in an orifice 134 formed on the shaft 132 of the roller.

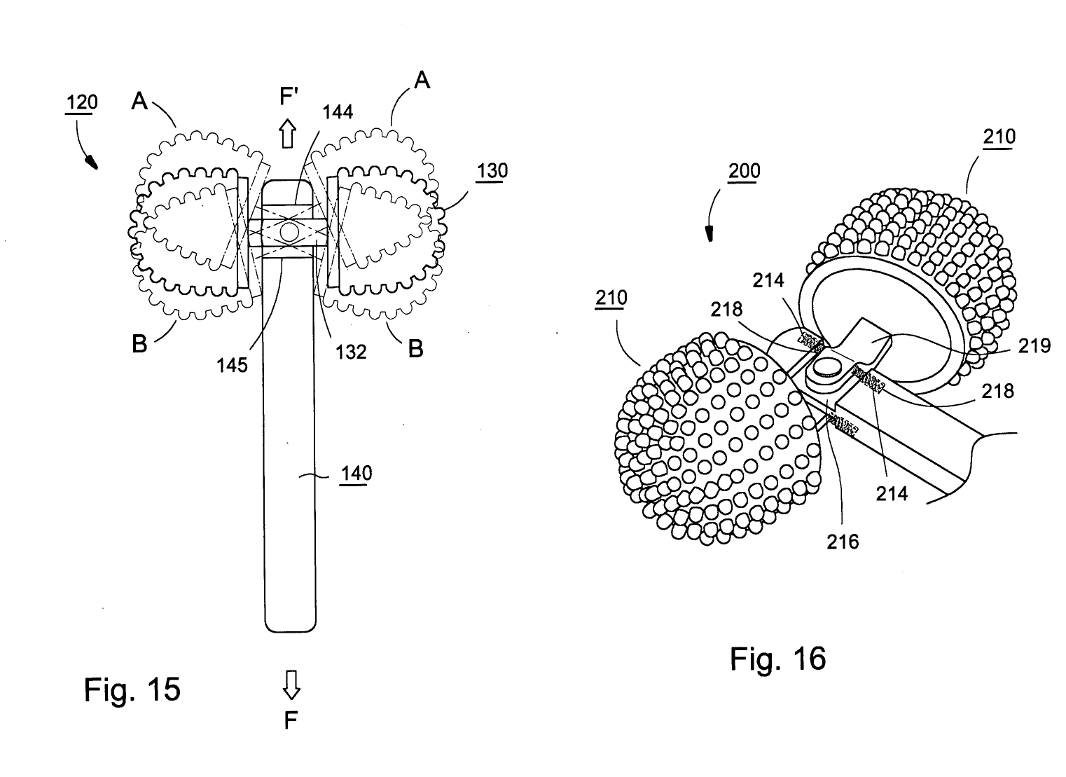

In use, referring to FIG. 15, when the massager 120 is pulled in direction F, due to reaction force, the rollers 130 will swing in reverse direction to the position shown by phantom line A. Therefore, the rollers and the handle 140 will automatically contain an angle. The front restricting portion 144 serves as a front dead end of the swing of the rollers 130, that is, when the shafts 132 of the rollers touch the front restricting portion 144, the rollers 130 are stopped. Accordingly, the rollers can press and inward knead the skin and muscle of a user. When the massager 120 is pushed in direction F′, the rollers 130 will swing in reverse direction to the position shown by phantom line B. Therefore, the rollers and the handle 140 will automatically contain an angle. The rear restricting portion 145 also serves as a rear dead end of the swing of the rollers 130. It should be noted that as shown by the phantom lines, when the rollers swing to touch the handle 140, the rollers 130 are also stopped. Therefore, the handle 140 can alternatively serve as the dead end of the -swing of the rollers instead of the restricting portions. Accordingly, the restricting portions are omissible.

In the embodiment, no matter whether the massager is pulled or pushed, the rollers will both swing in reverse direction. Therefore, the massager can be operated in any direction to provide an optimal kneading and massaging effect for human body.

When not used, the torque springs 150 will restore the rollers to the position shown by the solid line of FIG. 15. The torque springs 150 are also omissible. This will not affect the function of the massager.

FIG. 16 shows still another embodiment of the massager 200 of the present invention, which is similar to that of FIG. 12. The rollers 210 can freely swing on the handle 212. The difference between this embodiment and the embodiment of FIG. 12 is that the massager 200 has four compression springs 214 respectively mounted in four caves 218 formed on the front and rear walls of the depressions 216. The springs 214 serve to push the front and rear edges of the shafts 219 of the rollers 210.

Alternatively, the springs can be tension springs. Two ends of each tension spring are respectively connected with the shaft of the roller and the handle. This can achieve the same effect.

FIG. 17 shows still another embodiment of the massager 220 of the present invention, in which the rollers 230 are pivotally disposed on the same face of the handle 232. The rollers 230 can be pivotally disposed on the handle via two pivot shafts 234. Alternatively, the rollers 230 can be pivotally disposed on the handle via one single pivot shaft. The springs of the embodiments of FIGS. 12 and 16 are applicable to this embodiment.

The above embodiments are only used to illustrate the present invention, not intended to limit the scope thereof. Many modifications of the above embodiments can be made without departing from the spirit of the present invention.

What is claimed is:

1. A roller massager comprising:
a handle;
two rollers each having a shaft, a free end of the shaft being formed with at least one engaging portion;
at least one screwed member; the free ends of the shafts of the rollers being mounted on two sides of one end of the handle via the screwed member, whereby the angular position of the rollers relative to the handle is changeable; and
at least one engaging section, whereby when the rollers are fixed on the handle via the screwed member, the engaging section is engaged with the engaging portions of the rollers so as to locate the rollers in a specific angular position.

2. The roller massager as claimed in claim 1, wherein the engaging section is disposed on a top face of the handle; two engaging portions being respectively formed on a top and a bottom faces of the shaft of a first roller of the two rollers, the first roller being disposed on the top face of the handle via the screwed member, the bottom engaging portion of the first roller being engaged with the engaging section of the handle; an engaging portion being disposed on a bottom face of the shaft of a second roller of the two rollers, the second roller being disposed on a top face of the shaft of the first roller via the screwed member, the engaging portion of the second roller being engaged with the top engaging portion of the first roller.

3. The roller massager as claimed in claim 1, wherein two engaging sections are respectively formed on a top and a bottom faces of the handle; an engaging portion being disposed on a top face of the shaft of a first roller of the two rollers, the first roller being disposed under the bottom face of the handle via the screwed member, the engaging portion of the first roller being engaged with the bottom engaging section of the handle; an engaging portion being disposed on a bottom face of the shaft of a second roller of the two rollers, the second roller being disposed on the top face of the handle via the screwed member, the engaging portion of the second roller being engaged with the top engaging section of the handle.

4. The roller massager as claimed in claim 2, wherein each of the engaging section and the engaging portions includes a predetermined number of teeth which are annularly arranged and centered at the screwed member.

5. The roller massager as claimed in claim 3, wherein each of the engaging sections and the engaging portions includes a predetermined number of teeth which are annularly arranged and centered at the screwed member.

6. The roller massager as claimed in claim 1, wherein two engaging sections are formed on a top face of the handle; an engaging portion being disposed on a bottom face of each the shaft of the two rollers, the two rollers being disposed on the top face of the handle via two screwed members, the engaging portions of the rollers being respectively engaged with the engaging sections of the handle.

7. The roller massager as claimed in claim 1, wherein the engaging section is disposed on the handle and engaged with the engaging portions of the two rollers.

8. The roller massager as claimed in claim 7, wherein the engaging section is an upright pin and each of the engaging portions of the two rollers is composed of multiple annularly arranged holes, the pin being fitted through one of the holes of each roller.

9. The roller massager as claimed in claim 1, wherein the engaging section is disposed on the screwed member and engaged with the engaging portions of the two rollers.

10. The roller massager as claimed in claim 9, wherein the engaging section is an upright pin and each of the engaging portions of the two rollers is composed of multiple annularly arranged holes, the pin being fitted through one of the holes of each roller.

11. A roller massager comprising:
a handle;
two rollers each having a shaft; and
at least one central shaft, the free ends of the shafts of the rollers being pivotally connected with the handle via the central shaft, the two rollers being respectively positioned on two sides of the handle, whereby the two rollers can swing forward and backward about the central shaft, when the massager is pushed in a direction, the two rollers being forcedly swung in reverse direction.

12. The roller massager as claimed in claim 11, wherein the handle has at least one front restricting portion and at least one rear restricting portion for restricting the swing of the rollers within a certain range.

13. The roller massager as claimed in claim 12, wherein the handle is formed with at least one depression, a front and a rear walls of the depression respectively serving as the front and rear restricting portions, the two rollers being pivotally disposed in the depression.

14. The roller massager as claimed in claim 13, wherein the top face of the handle is formed with a depression in which both the rollers are pivotally disposed.

15. The roller massager as claimed in claim 13, wherein each of the top face and bottom face of the handle is formed with a depression, the two rollers being respectively pivotally disposed in the two depressions.

16. The roller massager as claimed in claim 11, further comprising a predetermined number of resilient members disposed between the handle and the two rollers for resiliently pushing the shafts of the rollers.

17. The roller massager as claimed in claim 16, wherein the resilient members are torque springs, one end of each torque spring being connected with the handle, while the other end of the torque spring being connected with the shaft of one of the rollers.

18. The roller massager as claimed in claim 16, wherein the resilient members are four springs, one end of each spring being connected with front and rear edges of the shafts of the two rollers, while the other end of each spring being connected with the handle.
